(19) United States
(12) Patent Application Publication
(10) Pub. No.: US 2016/0245431 A1
(43) Pub. Date: Aug. 25, 2016

(54) SAFETY APPARATUS AND METHODS FOR HIGH-PRESSURE CONDUITS

(71) Applicant: Gates Corporation, Denver, CO (US)

(72) Inventors: Mark Pratt, Blooming Grove, TX (US); Carl Francis White, Choctaw, OK (US); Rick Hill, Parker, CO (US); Kevin Allen White, Choctaw, OK (US); Andrew Hills, Eynesbury (GB)

(21) Appl. No.: 14/627,529

(22) Filed: Feb. 20, 2015

(51) Int. Cl. F16L 11/10; B23P 19/04; F16L 35/00

(52) U.S. Cl. CPC F16L 11/10; F16L 35/00; B23P 19/04

(57) ABSTRACT

A safety apparatus protects against human injury and loss of life by suppressing flow of fluid and broken pieces from a ruptured high-pressure conduit and provides pressure relief for escaping fluid. The safety apparatus includes a knitted fabric sleeve that encircles the high-pressure conduit. The sleeve may be secured to a coupling associated with the conduit by an attachment feature. The sleeve generally reduces the fluid velocity of the escaping fluid.

### BACKGROUND

1. Field

The present disclosure relates generally to apparatus and methods for protecting against human injury and loss of life due to catastrophic failures in the form of bursts or pin-hole failures in high-pressure fluid conduits such as hoses and tubes, and more particularly to a safety apparatus and methods for enclosing a length of a high-pressure conduit.

2. Related Art

As is well known within the hydraulics industry, injury resulting from hose bursts and pin-hole leaks can occur in a matter of milliseconds. Hydraulic systems may operate at very high pressures and fluid conduits can and have burst under these conditions, which can cause severe injury to nearby equipment and people. Sleeves are sometimes used to suppress the burst or pin-hole failures of the fluid conduits.

### SUMMARY

Embodiments of the disclosure may include a safety apparatus for a fluid conduit. The safety apparatus may include a knitted fabric sleeve disposed about the fluid conduit. The sleeve may define an interstitial space between the knitted fabric sleeve and the fluid conduit. The knitted fabric sleeve may be more stretchable in a radial direction than in an axial direction.

In some embodiments, the knitted fabric sleeve includes ribbing extending longitudinally in the axial direction of the knitted fabric sleeve. The knitted fabric sleeve may be substantially impervious to fluid in the fluid conduit. The knitted fabric sleeve may include liquid crystal polyester fibers. The knitted fabric sleeve may include multiple layers attached together only at opposing ends of the sleeve. The knitted fabric sleeve may include an outer layer and one or more inner layers. The outer layer may have a smaller diameter than the one or more inner layers. The safety apparatus may include an adjustable attachment feature that secures the knitted fabric sleeve to a coupling at an end of the fluid conduit.

Embodiments of the present disclosure may include a method. The method may include disposing a knitted fabric sleeve over a fluid conduit, the knitted fabric sleeve being more stretchable in a radial direction than in an axial direction. The method also may include establishing an interstitial space between the knitted fabric sleeve and the fluid conduit, and securing ends of the knitted fabric sleeve to ends of the fluid conduit. Securing the ends of the knitted fabric sleeve to ends of the fluid conduit may comprise adjusting one or more adjustment elements attached to the knitted fabric sleeve around couplings attached to ends of the fluid conduit.

In some embodiments, the knitted fabric sleeve includes ribbing extending longitudinally in the axial direction of the sleeve. The knitted fabric sleeve may be substantially impervious to fluid in the fluid conduit. The knitted fabric sleeve may include liquid crystal polyester fibers. The knitted fabric sleeve may include an outer layer and one or more inner layers. The outer layer may have a smaller diameter than the one or more inner layers.

Embodiments of the present disclosure may include a hose system. The hose system may include a high pressure hose, a knitted fabric sleeve disposed over the hose and defining an interstitial space between the knitted fabric sleeve and the hose, a coupling attached to each end of the hose, and an attachment feature attached to an end of the knitted fabric sleeve. The knitted fabric sleeve may be more stretchable in a radial direction than in an axial direction. The attachment feature may be adjustable.

In some embodiments, the knitted fabric sleeve includes ribbing extending longitudinally in the axial direction of the sleeve. The knitted fabric sleeve may be substantially impervious to fluid in the high pressure hose. The knitted fabric sleeve may include liquid crystal polyester fibers. The knitted fabric sleeve may include multiple layers attached together only at opposing ends of the knitted fabric sleeve. The knitted fabric sleeve may include an outer layer and one or more inner layers. The outer layer may have a smaller diameter than the one or more inner layers.

This summary of the disclosure is given to aid understanding, and one of skill in the art will understand that each of the various aspects and features of the disclosure may advantageously be used separately in some instances, or in combination with other aspects and features of the disclosure in other instances. Accordingly, while the disclosure is presented in terms of embodiments, it should be appreciated that individual aspects of any embodiment can be claimed separately or in combination with aspects and features of that embodiment or any other embodiment.

This summary is neither intended nor should it be construed as being representative of the full extent and scope of the present disclosure. The present disclosure is set forth in various levels of detail in this application and no limitation as to the scope of the claimed subject matter is intended by either the inclusion or non-inclusion of elements, components, or the like in this summary.

### BRIEF DESCRIPTION OF THE DRAWINGS

The accompanying drawings, which are incorporated in and form part of the specification in which like numerals designate like parts, illustrate examples of the present disclosure and together with the description, serve to explain the principles of the disclosure.

FIG. 1 is an isometric view of a fluid conduit system in accordance with some embodiments of the present disclosure.

FIG. 2 is an isometric view of a safety apparatus in accordance with some embodiments of the present disclosure.

FIG. 3 is an elevation view of the safety apparatus of FIG. 2 in accordance with some embodiments of the present disclosure.

FIG. 4 is an enlarged, fragmentary view of an end of the safety apparatus of FIG. 2 in accordance with some embodiments of the present disclosure.

FIG. 5 is an enlarged, fragmentary view of an end of the fluid conduit system of FIG. 1 in accordance with some embodiments of the present disclosure.

FIG. 6 is a fragmentary, longitudinal cross-section view of an end of the safety apparatus of FIG. 2 in accordance with some embodiments of the present disclosure.

FIG. 7 is a plan view of an attachment element of the safety apparatus of FIG. 2 in accordance with some embodiments of the present disclosure.

FIG. 8 is an elevation view of the attachment element of FIG. 7 in accordance with some embodiments of the present disclosure.

FIG. 9A is an enlarged, fragmentary view of a knitted fabric sleeve of the safety apparatus of FIG. 2 in accordance with some embodiments of the present disclosure.

FIG. 9B is an enlarged, fragmentary view of a knit pattern of the knitted fabric sleeve of FIG. 9A in accordance with some embodiments of the present disclosure.

FIG. 10 is a transverse cross-section view of the fluid conduit system of FIG. 1 in accordance with some embodiments of the present disclosure.

FIG. 11 is a schematic diagram of the fabric sleeve of FIG. 9A coupled to a tensile test apparatus for testing the fabric stretch of the sleeve in accordance with some embodiments of the present disclosure.

### DETAILED DESCRIPTION

The present disclosure is directed to apparatus and methods that provide protection to nearby equipment and persons after a high-pressure conduit has incurred damage in the form of a burst, pin-hole failure, or other damage. ISO 3457, EN474-1, and similar so called “line of sight” protection standards or guidelines state that for hoses carrying material (a fluid) at a pressure of 725 pounds per square inch (psi) or higher, wherein the hose assembly is located within one meter of an operator, or if the material carried within the hose exceeds 50 degrees Celsius, protection is required. A hose can unpredictably burst or develop a pin-hole at any location along its length, making protection very challenging. It would be beneficial to suppress fluid or shrapnel from a hose burst or pin-hole failure so that nearby equipment and persons are entirely protected from danger.

An example of a safety apparatus that provides protection of equipment and persons nearby a high pressure fluid conduit can be seen in embodiments of the present disclosure. The safety apparatus may include a sleeve disposed about a fluid conduit. The sleeve may be more stretchable in a radial direction than in an axial direction to decrease the velocity and pressure of fluid escaping from the fluid conduit. The safety apparatus may include an attachment feature that reliably and fixedly secures the safety apparatus to the fluid conduit. The various embodiments of the present disclosure are low-cost, simple to manufacture and implement at time of manufacture or as a retrofit, and are lightweight, elegant, and effective.

In some embodiments, a method of slidably disposing a sleeve over a fluid conduit may include establishing an interstitial space between the sleeve and the fluid conduit and securing ends of the sleeve to ends of the fluid conduit. The sleeve may be more stretchable in a radial direction than in an axial direction to decrease the velocity and pressure of fluid escaping from the fluid conduit.

In some embodiments, a hose system decreases the velocity and pressure of fluid escaping from a damaged conduit. The hose system may include a high pressure hose, with a sleeve disposed over the hose. The hose system may define an interstitial space between the sleeve and the hose. The sleeve is preferably more stretchable in a radial direction than in an axial direction to reduce the velocity and pressure of streams of high pressure fluid resulting from a pinhole puncture of the hose, and/or capable of containing or suppressing bursting of the hose, at a pressure above a rated pressure of the hose. Typically, a coupling or the like is disposed in each end of the hose, and an attachment feature secures each end of the sleeve to the coupling.

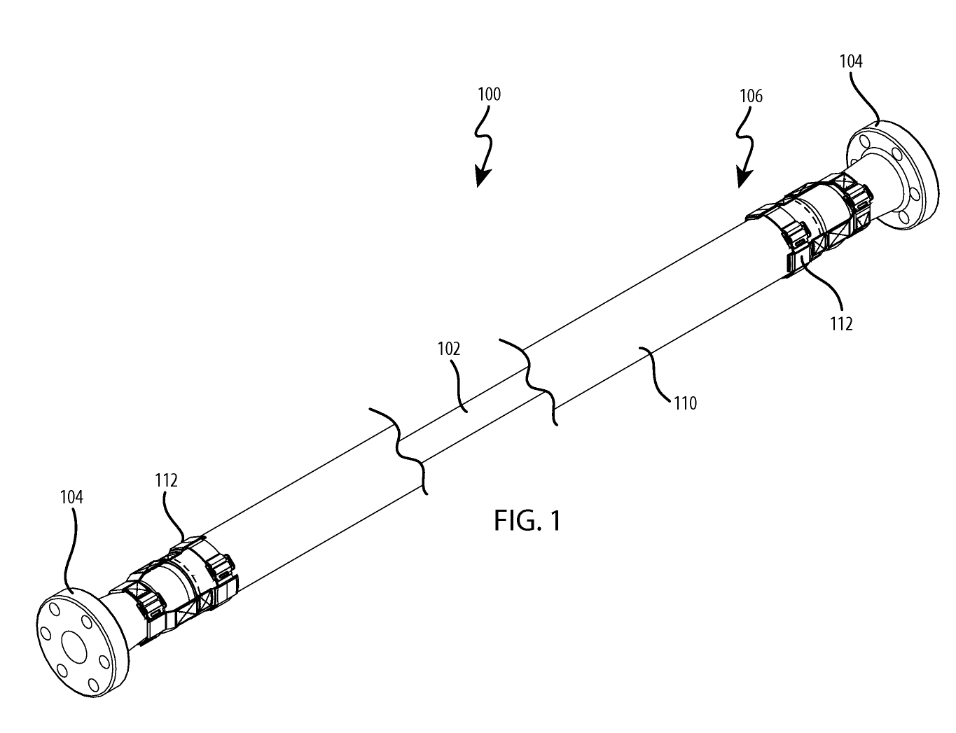

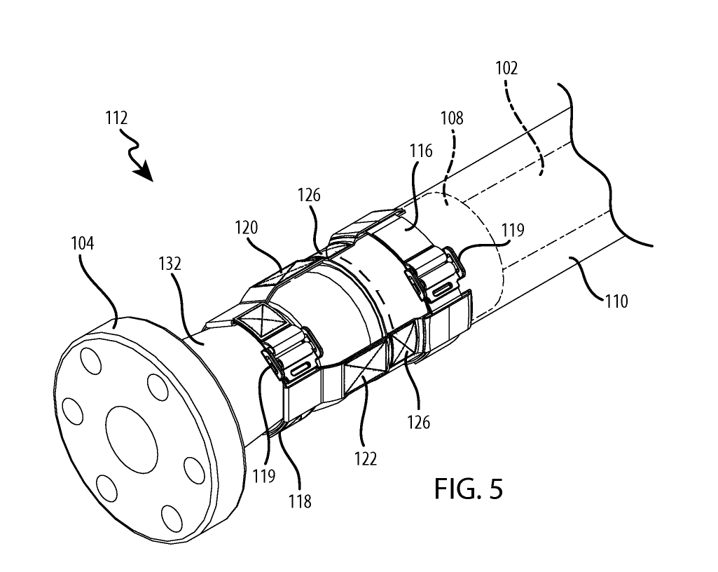

FIG. 1 shows a fluid conduit system 100 in accordance with some embodiments of the present disclosure. The fluid conduit system 100 may include a high-pressure fluid conduit 102, couplings 104 attached to opposing ends of the fluid conduit 102, and a safety apparatus 106 disposed around the fluid conduit 102 and attached to the couplings 104. In various embodiments, the high pressure conduit 102 may comprise hydraulic fluid conduits, such as hydraulic hose, line, or pipe. In typical hydraulic conduit construction, the couplings 104 include a stem that is insertable into an end of the conduit 102 and an interface feature such as a flange with bolt apertures allows other components to be attached to the conduit 102 to close a hydraulic circuit. To secure the stem in the conduit 102, a ferrule 108 (see FIG. 5) may be concentrically affixed about the conduit 102, typically by crimping, rolling, swaging, or other compression methods. The ferrule 108 may comprise carbon steel, stainless steel, Monel, cast iron, titanium, nano materials, aluminum, brass, and other machinable alloys as well as certain plastics such as resin polymer material.

Referring to FIG. 1, the safety apparatus 106 surrounds the fluid conduit 102. It should be understood the safety apparatus 106 may be used in conjunction with conduits or bundles of conduits of virtually any type or size including conduits in the farming, heavy duty equipment, aerospace, power, medical, oil, automotive, and other industries. In various embodiments, high pressure fluid in the form of a liquid may be carried by the conduit 102. However, it should be understood that the safety apparatus 106 can be applied to conduits carrying any type of material, including high pressure hydraulic fluids such as synthetic compounds, mineral oil, water, water-based mixtures, or any other material.

Referring still to FIG. 1, the safety apparatus 106 may include a sleeve 110 positioned around the fluid conduit 102. The sleeve 110 may comprise a full-length, but preferably otherwise slightly oversized, sleeve, which may encircle the entire circumference of the conduit 102. The sleeve 110 may define an interstitial space between the conduit 102 and the inner surface of sleeve 110. The sleeve 110 may extend along the entire length of conduit 102, so that a burst, pin-hole failure, or other form of damage to the conduit 102 is surrounded by the sleeve 110.

The sleeve 110 may be affixed to the conduit 102 by an attachment feature 112. The attachment feature 112 may be tightened snugly and concentrically around the sleeve 110 to attach the sleeve 110 to the conduit 102. The attachment feature 112 may be disposed near an end of the sleeve 110 and disposed around the ferrule 108 (see FIG. 5) to secure the sleeve 110 to the coupling 104. It should be understood by one of ordinary skill that the attachment feature 112 may be affixed to the conduit 102, the coupling 104, and/or the protective sleeve 110 before or after the sleeve 110 has been placed around the conduit 102.

The attachment feature 112 may be disposed around an end of the sleeve 110 and an associated coupling 104 to secure the sleeve to the conduit 102. The attachment feature 112 may secure the end of the sleeve between the attachment feature 112 and the coupling 104. The attachment feature 112 may be disposed over a ferrule 108 that secures the coupling 104 to an end of the fluid conduit 102. The attachment feature 112 may secure the end of the sleeve 110 between the attachment feature 112 and the ferrule 108.

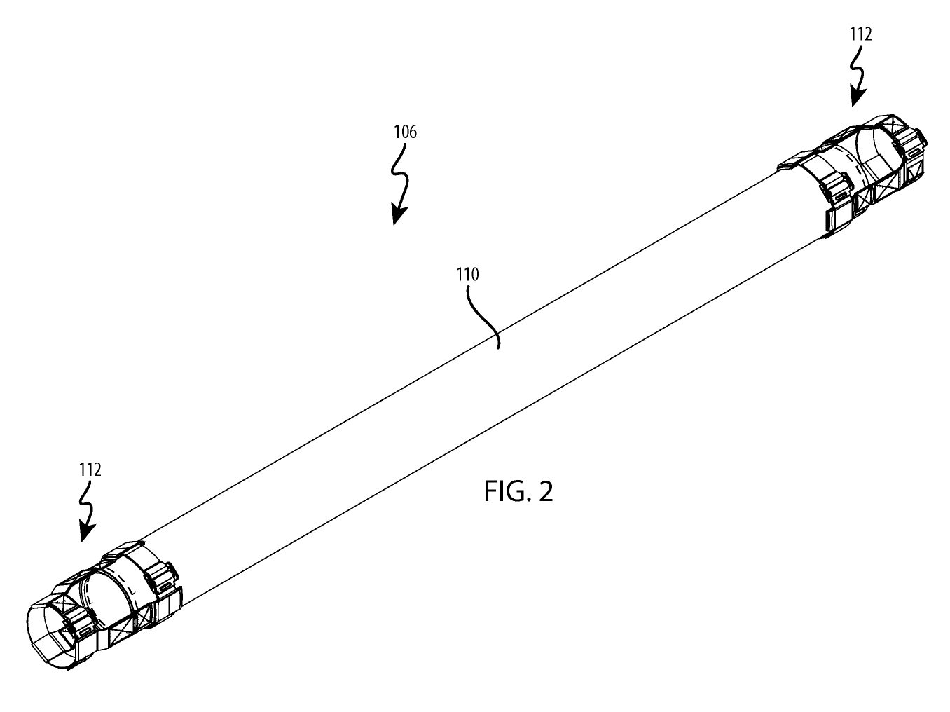

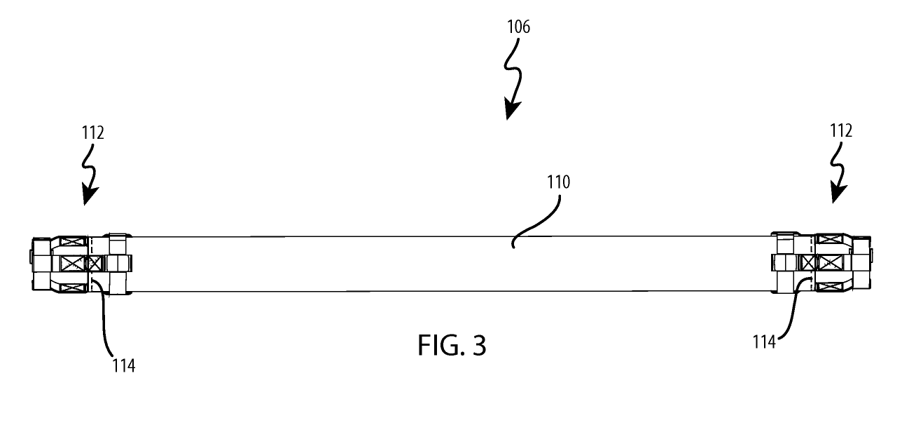

FIGS. 2 and 3 show different views of the safety apparatus 106 in accordance with some embodiments of the present disclosure. The safety apparatus 106 generally includes a pair of attachment features 112 attached to opposing ends of the sleeve 110. The sleeve 110 may be formed as an elongate tube. The length of the sleeve 110 is determined by the length of the fluid conduit 102 to cover. In some embodiments, the length of the sleeve 110 is greater than the length of the fluid conduit 102 to ensure the sleeve 110 surrounds the entire length of the conduit 102. The diameter of the sleeve 110 is determined by the diameter and pressure rating of the fluid conduit 102. The sleeve 110 has a larger inner diameter than an outer diameter of the fluid conduit 102 to define an interstitial space between the sleeve 110 and the fluid conduit 102. The sleeve 110 may be oversized relative to the fluid conduit 102 to ease installation of the sleeve 110 over the fluid conduit 102.

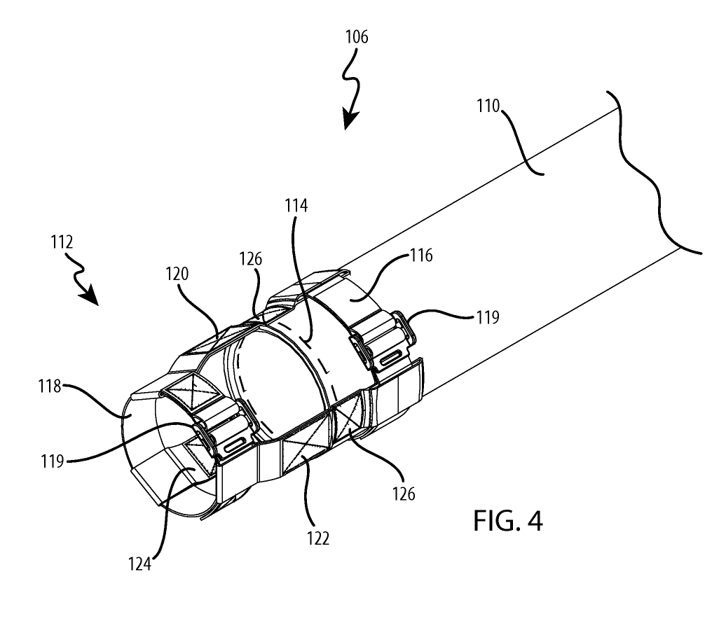

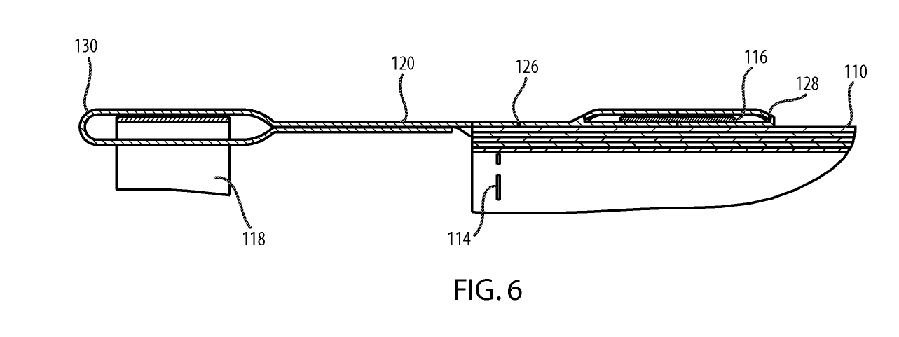

FIG. 4 shows an enlarged, fragmentary view of an end of the safety apparatus 106 in accordance with some embodiments of the present disclosure. The sleeve 110 may include multiple layers attached to one another at their ends (see FIG. 6). In some embodiments, the layers of the sleeve 110 are attached to one another by a circumferentially-extending line of stitching 114. The layers of the sleeve 110 extending along the length of the sleeve 110 are not attached to one another between the lines of stitching 114 to allow the layers to independently expand in a radial direction during conduit failure and reduce the velocity and pressure of the fluid escaping from the conduit 102.

Referring to FIGS. 4-6, the attachment feature 112 may be attached to a respective end of the sleeve 110. The attachment feature 112 may include multiple attachment elements, such as straps or webbing, for securing the sleeve 110 to the coupling 104. The attachment elements may include two adjustable straps 116, 118 spaced longitudinally apart from one another along a length dimension of the sleeve 110. The adjustable straps 116, 118 may be formed in a loop and may be adjustable to increase or decrease the inner dimension of the straps 116, 118 to loosen or tighten the straps 116, 118 around the sleeve 110. The first adjustable strap 116 may extend around the circumference of the sleeve 110 and may be tightened around the sleeve 110 to secure the sleeve 110 around an end of the fluid conduit 102. The second adjustable strap 118 may extend around the circumference of the coupling 104 and may be tightened around the coupling 104 to secure the sleeve 110 to the coupling 104. The straps 116, 118 may be identical or substantially identical to one another. Each strap 116, 118 may include a connector 119 for retaining the ends of the straps 116, 118 and forming the straps 116, 118 in an adjustable loop.

The straps 116, 118 may be attached to one another to prevent movement of the sleeve 110 relative to the coupling 104. In some embodiments, the adjustment feature 112 includes multiple longitudinally-extending connector straps 120, 122, 124 spaced equally around the sleeve 110. The connector straps 120, 122, 124 may be attached at one end to the first adjustable strap 116 and at an opposing end to the second adjustable strap 118. The length of the connector straps 120, 122, 124 may set the maximum longitudinal distance between the first and second adjustable straps 116, 118. The connector straps 120, 122, 124 may be fixedly attached to the end of the sleeve 110 by stitching 126, for example. It should be understood by one of ordinary skill that although three connector straps 120, 122, 124 are described, the attachment feature 112 may include more or less than three connector straps 120, 122, 124.

Referring to FIG. 6, each connector strap 120, 122, 124 may include closed loops 128, 130 formed at opposing ends of the straps 120, 122, 124. A first closed loop 128 may be formed at a first end of the connector straps 120, 122, 124 and may define receiving spaces for receiving the first adjustable strap 116. The first adjustable strap 116 may be routed through the receiving spaces of the first closed loops 128 of the connector straps 120, 122, 124 and may be tightened around the sleeve 110 to secure the sleeve 110 to the coupling 104. A second closed loop 130 may be formed at a second end of the connector straps 120, 122, 124 and may define receiving spaces for receiving the second adjustable strap 118. The second adjustable strap 118 may be routed through the receiving spaces of the second closed loops 130 of the connector straps 120, 122, 124 and may be tightened around the coupling 104 to secure the sleeve 110 at a second location along the coupling 104. As shown in FIG. 5, the second adjustable strap 118 may be securely tightened around a reduced outer diameter portion 132 of the coupling 104 to ensure the sleeve 110 does not move longitudinally along the conduit 102 and uncover an end of the conduit 102 during failure of the conduit 102.

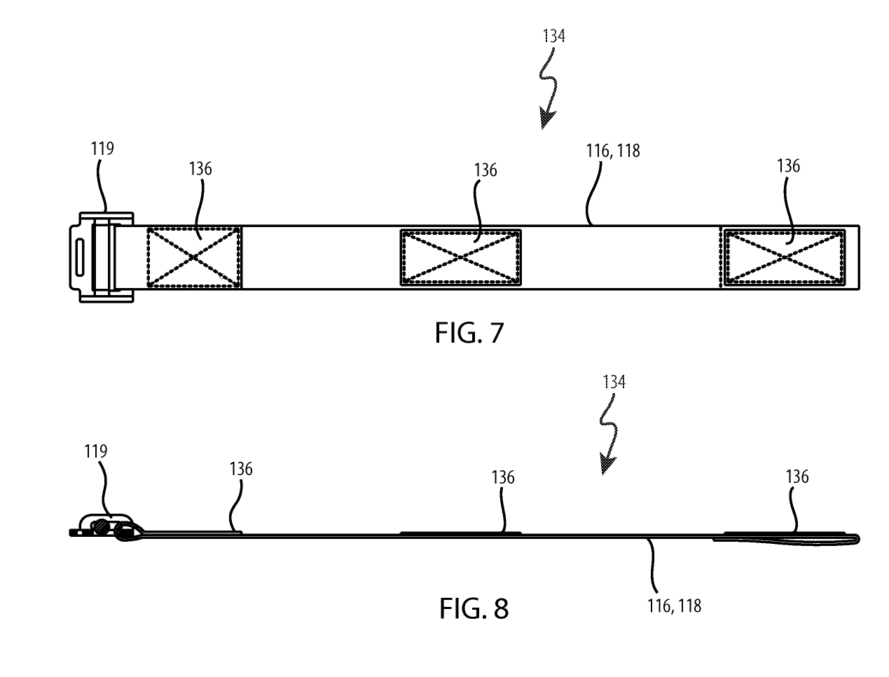

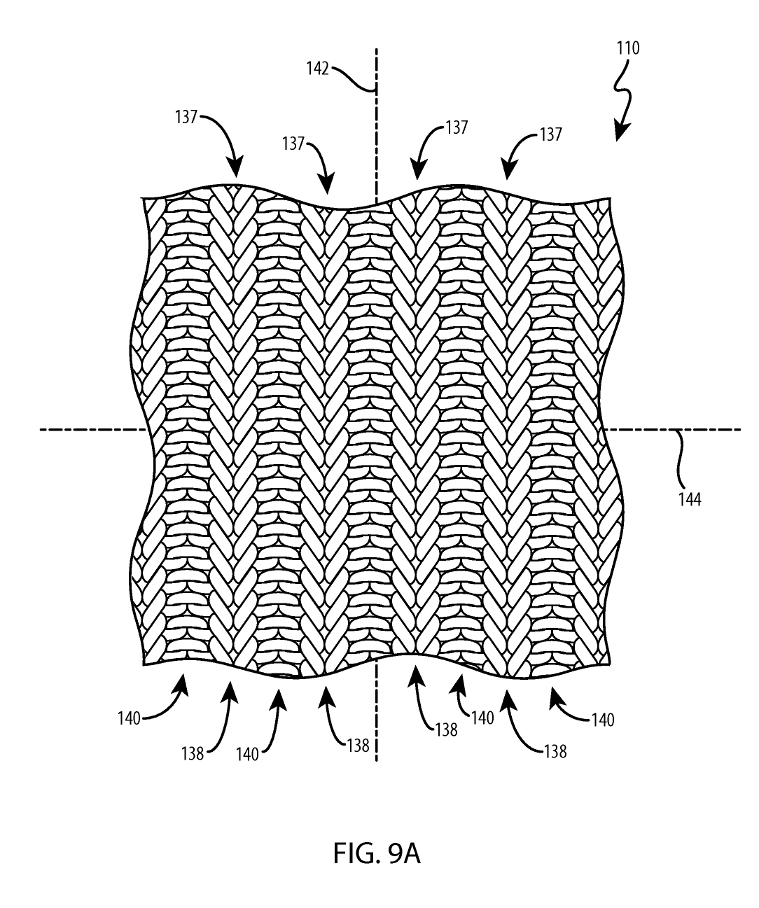

FIGS. 7 and 8 show different views of an attachment element 134 in accordance with some embodiments of the present disclosure. The attachment element 134 may include an adjustment strap, such as adjustment straps 116 or 118, and a connector 119 attached to a first end of the adjustment strap 116, 118. The adjustment strap 116, 118 may be formed into a loop around the sleeve 110 and a second end of the adjustment strap 116, 118 may be adjustably attached to the connector 119 by routing the second end around a transverse rail of the connector 119. The strap 116, 118 may then be tightened around the sleeve 110 and ferrule 108 of the coupling 104 (see FIG. 5). The attachment element 134 may include one or more fastening elements 136 for interfacing with the connector straps 120, 122, 124. The fastening elements 136 may be equally distributed along the length of the adjustable straps 116, 118 and may secure the connector straps 120, 122, 124 to the adjustable straps 116, 118. In some embodiments, the fastening elements 136 comprise one of a hook and loop fastener, and the other of the hook and loop fastener is secured to the connector strap 120, 122, 124 within the closed loops 128, 130 (see FIG. 6) to attach the connector straps 120, 122, 124 to the adjustable straps 116, 118 and set the circumferential position of the connector straps 120, 122, 124 relative to the adjustable straps 116, 118.

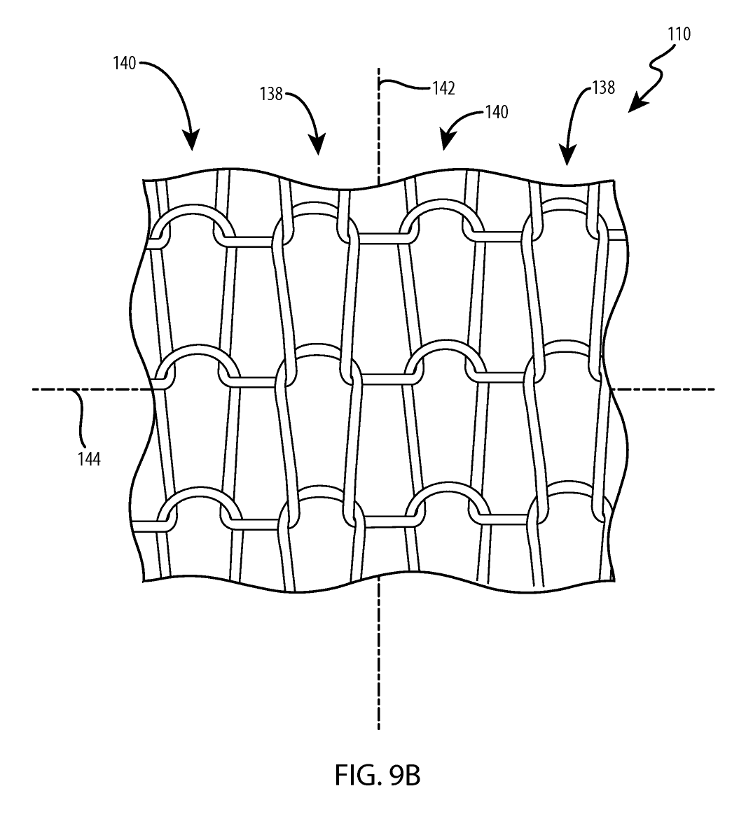

The sleeve 110 may be constructed of one or more layers of knitted fabric. FIG. 9A shows a portion of the knitted fabric sleeve 110. The knitted fabric sleeve 110 includes vertical columns of ribs 137 resulting from alternating knit stitches 138 and purl stitches 140. Within each horizontal row of the knitted fabric sleeve 110, a knit stitch 138 alternates with a purl stitch 140. The knit stitches 138 form ribs 137 on one side of the knitted fabric sleeve 110, and the purl stitches 140 form ribs on the opposite side of the knitted fabric sleeve 110. The ribs 137 are oriented longitudinally (running in direction 142) along the length of the knitted fabric sleeve 110, resulting in more stretch in the width or radial direction (direction 144) of the sleeve 110. Referring to FIG. 9B, an enlarged, fragmentary knit pattern of the knitted fabric sleeve 110 is provided. As shown in FIG. 9B, the knit stitches 138 and the purl stitches 140 may intermesh alternately on the face and the back of the knitted fabric sleeve 110.

Referring to FIGS. 9A and 9B, the knitted fabric sleeve 110 may include an even ribbing combination. That is, the number of columns of knit stitching 138 is the same as the number of columns of purl stitching 140. FIGS. 9A and 9B show the knitted fabric sleeve 110 with 1×1 ribbing. That is, single knit stitches 138 alternate with single purl stitches 140, creating narrow ribs 137. The ribs 137 extend the full length of the knitted fabric sleeve 110. Other patterns of ribbing 137 may be used. In some embodiments, the knitted fabric sleeve 110 includes 2×2 ribbing having two knit stitches alternating with 2 purl stitches.

The knitted fabric sleeve 110 may be substantially impervious in that it may slow the velocity of a high velocity and/or high-temperature stream or burst of escaping material from a location of damage along the length of conduit. Preferably, the sleeve 110 is impermeable to a point that it only allows suppressed fluid to seep or weep through the sleeve 110, with little, or no, discernible energy. The knitted fabric sleeve 110 may be constructed of a substantially impervious material which will stop the stream of fluid produced by a pin-hole puncture or other breach in the conduit 102 at an elevated pressure, such as at twice the rated pressure of the conduit 102.

The knitted fabric sleeve 110 may be reinforced with fibers. The fibers may be incorporated in the rib stitches 138 and may extend lengthwise along the full length of the knitted fabric sleeve 110. In some embodiments, the fibers are comprised of synthetic high-performance fibers, such as poly(p-phenylene-2,6-benzobisoxazole), polyester, polyamide, polyolefins, including ultra-high-molecular-weight polyethylene, or aramid. In some embodiments, the knitted fabric sleeve 110 is reinforced with aromatic polyester and/or liquid crystal polymer, which are offered under the trademark Vectran®. These fibers have thermal stability at high temperatures, high strength and modulus, low creep, and good chemical stability. These fibers also are moisture resistant and generally stable in hostile environments. These fibers may be used in combination with a polyester or polyurethane coating around a Vectran® core to improve abrasion resistance and act as a water barrier. These fibers also have a high resistance to ultraviolet radiation for extended use in the field.

Referring still to FIG. 9, the knitted fabric sleeve 110 may have different stretch properties in different directions. The knitted fabric sleeve 110 may include reinforcing fibers extending lengthwise along a length direction 142 of the sleeve 110 to reduce the stretch capability but increase the strength of the sleeve 110 in a lengthwise direction. The reduced stretch of the sleeve 110 in the length direction 142 may facilitate retention of the sleeve 110 around the couplings 104. The knitted fabric sleeve 110 may be more stretchable in a radial or width direction 144 than in a length direction 142. Referring to FIG. 9, the radial or width direction 144 of the knitted fabric sleeve 110 may extend perpendicular to the ribs 137 and may be defined by the circular knitting direction or courses. The length direction 142 may extend parallel to the ribs 137 or wales of the knitted fabric sleeve 110. During failure of the fluid conduit 102, the sleeve 110 may expand in the radial or width direction 144 to increase the diameter of the sleeve 110 and absorb the energy of the escaping fluid.

The sleeve 110 may have a fabric stretch in the length or longitudinal direction 142 per ASTM D2594-99a (with a 5 pound-force load) of less than 20%. In some embodiments, the sleeve 110 has a fabric stretch in the length or longitudinal direction 142 per ASTM D2594-99a (with a 5 pound-force load) of less than 10%. In some embodiments, the sleeve 110 has a fabric stretch in the length or longitudinal direction 142 per ASTM D2594-99a (with a 5 pound-force load) of between about 5% and about 10%. In some embodiments, the sleeve 110 has a fabric stretch in the length or longitudinal direction 142 per ASTM D2594-99a (with a 5 pound-force load) of about 8%.

The sleeve 110 may have a fabric stretch in the radial or width direction 144 per ASTM D2594-99a (with a 5 pound-force load) of greater than 50%. In some embodiments, the sleeve 110 has a fabric stretch in the radial direction 144 per ASTM D2594-99a (with a 5 pound-force load) of between about 50% and about 100%. In some embodiments, the sleeve 110 has a fabric stretch in the radial direction 144 per ASTM D2594-99a (with a 5 pound-force load) of between about 60% and about 90%. In some embodiments, the sleeve 110 has a fabric stretch in the radial direction 144 per ASTM D2594-99a (with a 5 pound-force load) of about 75%.

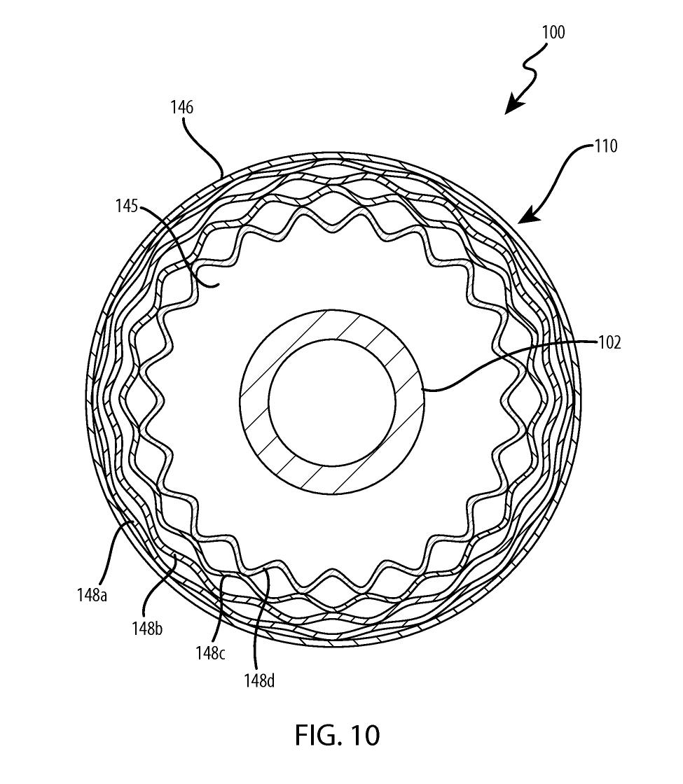

The knitted fabric sleeve 110 may include one layer or multiple layers of similar or different materials depending on the performance needs of the sleeve 110. The size, thickness, strength, and the like of the sleeve 110 can be selected to suit a particular fluid conduit 102 application. FIG. 10 shows a transverse cross-section view of a fluid conduit system 100 taken along a length of the sleeve 110 between the attachment features 112 in accordance with some embodiments of the present disclosure. The sleeve 110 surrounds the fluid conduit 102 to protect nearby equipment and persons. The sleeve 110 may have a larger inner diameter than an outer diameter of the fluid conduit 102 to define an annular or interstitial space 145 between the sleeve 110 and the fluid conduit 102. The interstitial space 145 may provide space for fluid to accumulate during failure of the fluid conduit 102. The interstitial space 145 may grow in volume during failure as the knitted fabric sleeve 110 radially expands during failure of the fluid conduit 102 under the pressure of the escaping fluid. As shown in FIGS. 6 and 10, the sleeve 110 may include multiple layers attached together only at opposing ends of the sleeve 110. In some embodiments, the layers are attached together with lines of stitching 114, but only at the ends. In some embodiments, the multiple knit layers are not in any way restricted radially by any other non-expansive or less-expansive material, strap, fabric, or stitching, or attached to each other except at the ends as shown and described.

Referring to FIG. 10, the knitted fabric sleeve 110 may include an outer layer 146 and one or more inner layers 148. In FIG. 10, the sleeve 110 includes four inner layers 148a, 148b, 148c, 148d, collectively referred to as inner layers 148. It should be understood by one of ordinary skill the number of layers may change depending on the performance requirements of the sleeve 110, which may be determined by the pressure and volume of fluid in the fluid conduit 102. In one particular application, the sleeve 110 includes one outer layer 146 and seven inner layers 148 for protecting against injury resulting from failure of a 3.5 inch high-pressure hose.

The outer layer 146 and the inner layers 148 may have different diameters. In some embodiments, the outer layer 146 has a smaller outer diameter than the one or more inner layers 148. The smaller outer diameter of the outer layer 146 may slightly restrain the expansion of the inner layers 148 during failure of the fluid conduit 102. The inner layers 148 may have the same outer diameters. In one particular application for a 3.5 inch high-pressure hose, the outer layer 146 is 7.75 inches tubular or 15.5 inches open width, and the inner layers 148 are 8.375 inches tubular or 16.75 inches open width.

The outer layer 146 and the inner layers 148 may be constructed of the same or substantially the same knit pattern. In some embodiments, the outer layer 146 and the inner layers 148 include 1×1 ribbing extending lengthwise along the length of the sleeve 110. In some embodiments, the outer layer 146 has slightly different courses and wales per inch than the inner layers 148. In some embodiments, the outer layer 146 has fewer courses per inch and fewer wales per inch than the inner layers 148. In some embodiments, the inner and outer layers are substantially of the same knit construction and dimensions, within normal knitting tolerances. In one particular application for a 3.5 inch high pressure hose, the outer layer 146 may have 19.5 courses per inch (plus or minus 3 courses per inch), and the inner layers 146 may have 19 courses per inch (plus or minus 3 courses per inch). In this particular application, the outer layer 146 may have 15.52 wales per inch (plus or minus 3 wales per inch) and the inner layers may have 16.59 wales per inch (plus or minus 3 wales per inch). It should be understood by one of ordinary skill in the art the number of courses per inch and wales per inch may vary depending on the performance requirements of the sleeve 110.

The outer layer 146 and the inner layers 148 may be constructed of the same material. In some embodiments, the outer layer 146 and the inner layers 148 are constructed of yarns reinforced with (or comprising or even consisting of) liquid crystal polymer fibers, such as those sold under the trademark Vectran®. The outer layer 146 and the inner layers 148 may have the same linear mass density. In some embodiments, the outer layer 146 and the inner layers 148 are 800 denier. It should be understood by one of ordinary skill the denier may vary depending on the particular fluid conduit 102 application. The outer layer 146 and the inner layers 148 may include a durable water repellant finish.

The outer layer 146 and the inner layers 148 may have substantially the same fabric stretch characteristics in the length or longitudinal direction 142. In some embodiments, the outer layer 146 and the inner layers 148 each have a fabric stretch in the length or longitudinal direction 142 per ASTM D2594-99a (with a 5 pound-force load) of less than 20%. In some embodiments, the outer layer 146 and the inner layers 148 each have a fabric stretch in the length or longitudinal direction 142 per ASTM D2594-99a (with a 5 pound-force load) of less than 10%. In some embodiments, the outer layer 146 and the inner layers 148 each have a fabric stretch in the length or longitudinal direction 142 per ASTM D2594-99a (with a 5 pound-force load) of between about 5% and about 10%. In some embodiments, the outer layer 146 and the inner layers 148 each have a fabric stretch in the length or longitudinal direction 142 per ASTM D2594-99a (with a 5 pound-force load) of about 8%.

The outer layer 146 and the inner layers 148 may have substantially the same, similar, or different fabric stretch characteristics in the width or radial direction 144. The outer layer 146 may have a fabric stretch in the radial or width direction 144 per ASTM D2594-99a (with a 5 pound-force load) of greater than 50%. In some embodiments, the outer layer 146 has a fabric stretch in the radial direction 144 per ASTM D2594-99a (with a 5 pound-force load) of between about 50% and about 90%. In some embodiments, the outer layer 146 has a fabric stretch in the radial direction 144 per ASTM D2594-99a (with a 5 pound-force load) of between about 60% and about 80%. In some embodiments, the outer layer 146 has a fabric stretch in the radial direction 144 per ASTM D2594-99a (with a 5 pound-force load) of about 70%. Each inner layer 148 may have a fabric stretch in the radial or width direction 144 per ASTM D2594-99a (with a 5 pound-force load) of greater than 50%. In some embodiments, each inner layer 148 has a fabric stretch in the radial direction 144 per ASTM D2594-99a (with a 5 pound-force load) of between about 70% and about 100%. In some embodiments, each inner layer 148 has a fabric stretch in the radial direction 144 per ASTM D2594-99a (with a 5 pound-force load) of between about 80% and about 90%. In some embodiments, each inner layer 148 has a fabric stretch in the radial direction 144 per ASTM D2594-99a (with a 5 pound-force load) of about 85%.

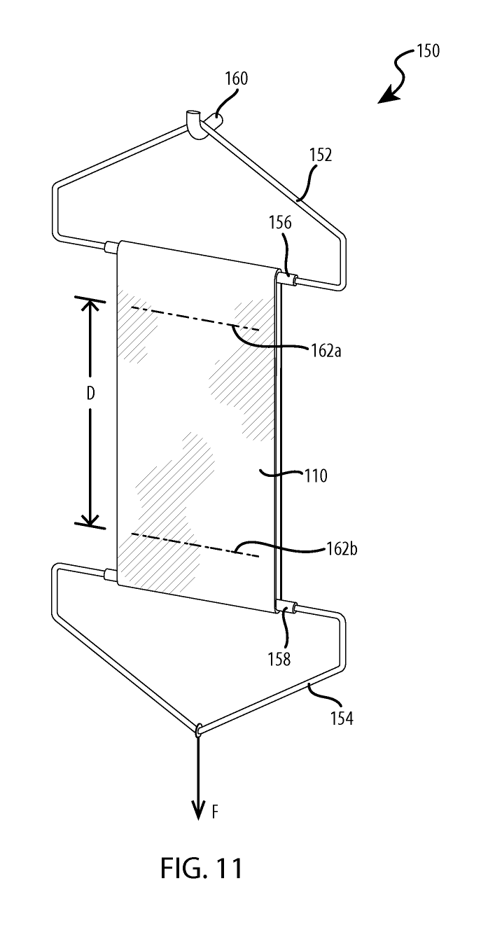

FIG. 11 is a schematic diagram of the fabric sleeve of FIG. 9A coupled to a tensile test apparatus in accordance with some embodiments of the present disclosure. The tensile test apparatus is schematically represented as a hanger assembly 150 including an upper hanger 152, a lower hanger 154, an upper hanger rod 156 attached to the upper hanger 152, a lower hanger rod 158 attached to the lower hanger 154, and a support 160 coupled to the upper hanger 152. The sleeve 110 is represented as being formed in a tube that is disposed around the upper and lower hanger rods 156, 158 of the upper and lower hangers 152, 154, respectively. A force F is schematically represented as being applied to the lower hanger 154 to stretch the sleeve 110 between the upper and lower hangers 152, 154. The actual test was conducted using a tensile tester manufactured by Instron.

To test the fabric stretch of the sleeve 110 in the radial direction 144 (see FIG. 9A), a radial test specimen was formed by obtaining an approximately five-inch long section of the tubular sleeve 110, and positioning the sleeve 110 around the hanger rods 156, 158 such that the ribs 137 were oriented parallel to the hanger rods 156, 158. To test the fabric stretch of the sleeve 110 in the longitudinal direction 142 (see FIG. 9A), an approximately 15.5 inch piece of the tubular sleeve 110 of FIG. 9A was cut lengthwise parallel to the ribs 137, folded and stitched into a loop such that each rib 137 formed a continuous ring, and the loop was positioned around the hanger rods 156, 158 such that radial direction 144 of the sleeve 110 of FIG. 9A was oriented parallel to the hanger rods 156, 158. An upper mark 162a and a lower mark 162b (collectively referred to as the marks 162) were formed on an outer surface of the sleeve 110 parallel to the hanger rods 156, 158 and were located at a known distance D apart from one another.

Each test specimen was stretch tested by first cycling the applied force F four times between 0 and 5 lbf, allowing four to six seconds to complete each cycle. Then, a fifth cycle was started, and the applied force F was held at 5 lbf for five to ten seconds. During the holding time period, the distance D between the marks 162 was measured. The fabric stretch was calculated by subtracting the original distance (distance D between the marks 162 measured prior to applying force F) from the tensioned distance (distance D between the marks 162 measured while the tension force F was being applied to the specimen), dividing that net distance by the original distance, and multiplying the resulting number by 100.

As an Example of an embodiment of the invention, a single outer layer 146 and a single inner layer 148 of the sleeve 110, 1×1 circular rib knit of Vectran® liquid crystal polymer 800-denier yarn, approximately 19 courses per inch and 16 wales per inch (˜250 wales in circumference), were independently stretch tested in the longitudinal direction 142 and the radial direction 144 (see FIGS. 9A and 10) pursuant to ASTM D2594-99a with a five pound-force load. The outer layer was black-colored Vectran® and the inner layer was natural-colored. The outer layer 146 had a fabric stretch in the longitudinal direction 142 of 8.2% and a fabric stretch in the radial direction 144 of 68.4%. The inner layer 148 had a fabric stretch in the longitudinal direction 142 of 8.4% and a fabric stretch in the radial direction 144 of 84.4%. The fabric stretch of the sleeve 110 may be altered by changing the material, dimensions, weave pattern, or other suitable characteristics of the outer layer 146, one or more of the inner layers 148, or any combination thereof to tailor the stretch properties of the sleeve 110 to a particular application.

An Example safety apparatus having seven inner layers of the above circular knit and one outer layer was constructed according to an embodiment of the invention. The Example included stitching 114 to hold the eight layers together only at opposite ends. Attachment features 112 were fixedly attached only at opposite ends. The knit layers were not otherwise restricted or attached to each other except at the ends as described. The sleeve was applied to a length of 3½-inch, grade-D, steel-cable-reinforced, high-pressure hose. The attachment features were secured to couplings at either end of the hose assembly. The hose, having been scored into the outer cable layer in order to induce a controlled burst, was then pressurized at a rate of about 3 bars/s. Burst occurred at approximately 10,000 psi (˜700±100 bars). The test was repeated on two Example specimens, resulting in only one or two inner layers, respectively, of knit fabric receiving any damage, and the ruptured hose being entirely contained.

As a first comparative example, the same construction as the Example was made but with additional reinforcing straps 116 attached circumferentially thereto at intermediate locations approximately every foot of hose length, i.e., not only restricted at the respective ends. The first comparative sleeve failed to contain the rupture.

As a second comparative example, a similar construction as the Example was made but with a tightly square-woven Kevlar® ballistic cloth used as the innermost and outer layers, with six layers of the Vectran® circular knit from the Example there between. The stitching, attachment features, and testing were carried out as in the Example. The second comparative example failed to contain the burst, which ripped through all eight layers of fabric.

Referring back to FIGS. 1-5, to assemble the fluid conduit system 100, one or more layers of the sleeve 110 may be fixedly attached to one another only along their respective ends. In some embodiments, the one or more layers of the sleeve 110 are stitched together along circumferentially-extending lines of stitching 114. Attachment features 112 may be fixedly secured to ends of the sleeve 110. In some embodiments, connector straps 120, 122, 124 are attached to ends of the sleeve 110. The connector straps 120, 122, 124 may be spaced evenly around a periphery of the sleeve 110 and may be fixedly secured to the sleeve 110 by stitching, for example.

The connector straps 120, 122, 124 may extend lengthwise along a length of the end of the sleeve 110 and may include a portion extending beyond the end of the sleeve 110. A first adjustable strap 116 may be routed through loops 128 formed in ends of the connector straps 120, 122, 124. A second adjustable strap 118 may be routed through loops 130 formed in opposing ends of the connector straps 120, 122, 124 that are cantilevered from the end of the sleeve 110. The sleeve 110 may be disposed over a fluid conduit 102 and may be oversized relative to the fluid conduit 102 so as to define an interstitial space between the sleeve 110 and the fluid conduit 102. The first adjustable strap 116 may be tightened around a ferrule 108 disposed around an end of the fluid conduit 102, and the second adjustable strap 118 may be tightened around a coupling 104 attached to the end of the fluid conduit 102. The first and second adjustable straps 116, 118 may secure the ends of the sleeve 110 around the ends of the fluid conduit 102 to ensure fluid or broken conduit pieces escaping from a failure of the fluid conduit 102 is suppressed by the sleeve 110 to prevent damage to nearby equipment or persons. The attachment features 112 are attached only at ends of the sleeve 110 to permit radial expansion of the sleeve 110 during failure of the fluid conduit 102. The safety and well-being of persons standing nearby and/or operating or maintaining the hydraulic system, commonly known as line of sight protection, is achieved at least in part by providing a secure means of attachment of the sleeve 110 to the conduit 102.

In summary, many industries can take advantage of the embodiments of the present safety apparatus and methods for high pressure conduits. The safety apparatus may be applied to any high pressure conduit in a retrofit manner or during production. The resultant protection is effective for conduits carrying even very high pressure fluids. The safety apparatus preferably prevents injury to the operator and/or damage to the associated equipment. The safety apparatus may include a knitted fabric sleeve, which may have two-directional stretch properties. In some embodiments, the knitted fabric sleeve expands or stretches more radially than longitudinally. The knitted fabric sleeve may be formed as a tubular fabric or as an open-width fabric including longitudinally-extending edges that are secured together to form a tubular construction. The knitted fabric sleeve may include one or more layers that are attached together at their ends. Each layer may be slipped into a next consecutive layer and stitched together at their ends. The layers may be portions of a single knit tube slipped into or over itself. Attachment features may be attached to each end of the sleeve to secure the sleeve to the fluid conduit. In some embodiments, the sleeve does not include a ballistic cover for abrasion resistance because the ballistic cover overly restricts the radial expansion or stretching of the knitted fabric sleeve. In some embodiments, the sleeve has features, such as stitching, that may restrict the natural radial stretchiness of the sleeve only at the ends of the sleeve. The sleeve may be used in high-pressure applications with, but not limited to, 3-4″ hose, which may include rubber or plastic and may include reinforcing cables, wires, or yarns.

The foregoing discussion has been presented for purposes of illustration and description and is not intended to limit the disclosure to the form or forms disclosed herein. For example, various features of the disclosure are grouped together in one or more aspects, embodiments, or configurations for the purpose of streamlining the disclosure. However, it should be understood that various features of the certain aspects, embodiments, or configurations of the disclosure may be combined in alternate aspects, embodiments, or configurations. Moreover, the following claims are hereby incorporated into this Detailed Description by this reference, with each claim standing on its own as a separate embodiment of the present disclosure.

All directional references (e.g., proximal, distal, upper, lower, upward, downward, left, right, lateral, longitudinal, front, back, top, bottom, above, below, vertical, horizontal, radial, axial, clockwise, and counterclockwise) are only used for identification purposes to aid the reader's understanding of the present disclosure, and do not create limitations, particularly as to the position, orientation, or use of this disclosure. Connection references (e.g., attached, coupled, connected, and joined) are to be construed broadly and may include intermediate members between a collection of elements and relative movement between elements unless otherwise indicated. As such, connection references do not necessarily infer that two elements are directly connected and in fixed relation to each other. Identification references (e.g., primary, secondary, first, second, third, fourth, etc.) are not intended to connote importance or priority, but are used to distinguish one feature from another. The drawings are for purposes of illustration only and the dimensions, positions, order and relative sizes reflected in the drawings attached hereto may vary.

What is claimed is:

1. A safety apparatus for a fluid conduit, comprising:
a knitted fabric sleeve disposed about the fluid conduit and defining an interstitial space between the knitted fabric sleeve and the fluid conduit, the knitted fabric sleeve more stretchable in a radial direction than in an axial direction.

2. The safety apparatus of claim 1, wherein the knitted fabric sleeve includes ribbing extending longitudinally in the axial direction.

3. The safety apparatus of claim 1, wherein the knitted fabric sleeve is substantially impervious to fluid in the fluid conduit.

4. The safety apparatus of claim 1, wherein the knitted fabric sleeve includes liquid crystal polyester fibers.

5. The safety apparatus of claim 1, wherein the knitted fabric sleeve includes multiple layers attached together only at opposing ends of the knitted fabric sleeve.

6. The safety apparatus of claim 1, wherein the knitted fabric sleeve includes multiple circular knit layers, and wherein each layer exhibits fabric stretch according to ASTM D2594-99a with a 5-lbf load of less than 20% in the longitudinal direction and greater than 50% in the radial direction.

7. The safety apparatus of claim 1, wherein the safety apparatus further comprises an adjustable attachment feature that secures the knitted fabric sleeve to a coupling at an end of the fluid conduit.

8. A method comprising:
disposing a knitted fabric sleeve over a fluid conduit, the knitted fabric sleeve being more stretchable in a radial direction than in an axial direction;
establishing an interstitial space between the knitted fabric sleeve and the fluid conduit; and
securing ends of the knitted fabric sleeve to ends of the fluid conduit.

9. The method of claim 8, wherein the knitted fabric sleeve includes ribbing extending longitudinally in the axial direction.

10. The method of claim 8, wherein the knitted fabric sleeve is substantially impervious to fluid in the fluid conduit.

11. The method of claim 8, wherein the knitted fabric sleeve includes liquid crystal polyester fibers.

12. The method of claim 8, wherein the knitted fabric sleeve includes multiple circular knit layers, and wherein each layer exhibits fabric stretch according to ASTM D2594-99a with a 5-lbf load of less than 20% in the longitudinal direction and greater than 50% in the radial direction.

13. The method of claim 8, wherein securing ends of the knitted fabric sleeve to ends of the fluid conduit comprises adjusting one or more adjustment elements attached to the knitted fabric sleeve around couplings attached to ends of the fluid conduit.

14. A hose system comprising:
a high pressure hose;
a knitted fabric sleeve disposed over the hose and defining an interstitial space between the knitted fabric sleeve and the hose, the knitted fabric sleeve more stretchable in a radial direction than in an axial direction;
a coupling attached to each end of the hose; and
an attachment feature attached to an end of the knitted fabric sleeve.

15. The hose system of claim 14, wherein the knitted fabric sleeve includes ribbing extending longitudinally in the axial direction.

16. The hose system of claim 14, wherein the knitted fabric sleeve is substantially impervious to fluid in the high pressure hose.

17. The hose system of claim 14, wherein the knitted fabric sleeve includes liquid crystal polyester fibers.

18. The hose system of claim 14, wherein the knitted fabric sleeve includes multiple layers attached together only at opposing ends of the knitted fabric sleeve.

19. The hose system of claim 14, wherein the knitted fabric sleeve includes multiple circular knit layers, and wherein each layer exhibits fabric stretch according to ASTM D2594-99a with a 5-lbf load of less than 20% in the longitudinal direction and greater than 50% in the radial direction.

20. The hose system of claim 14, wherein the attachment feature is adjustable.
